(19) United States
(12) Patent Application Publication
(10) Pub. No.: US 2024/0030977 A1
(43) Pub. Date: Jan. 25, 2024

(54) PARTIAL CHANNEL STATE INFORMATION REPORTING

(71) Applicant: QUALCOMM Incorporated, San Diego, CA (US)

(72) Inventors: Kiran VENUGOPAL, Green Brook, NJ (US); Wooseok NAM, San Diego, CA (US); Tao LUO, San Diego, CA (US); Junyi LI, Fairless Hills, PA (US)

(21) Appl. No.: 17/813,841

(22) Filed: Jul. 20, 2022

(51) Int. Cl. H04B 7/06; H04W 24/10; H04L 5/00

(52) U.S. Cl. CPC H04B 7/0626; H04B 7/0639; H04W 24/10; H04L 5/0053

(57) ABSTRACT

Various aspects of the present disclosure generally relate to wireless communication. In some aspects, a user equipment (UE) may receive a configuration for partial channel state information (CSI) reports, each partial CSI report having less information than a full CSI report that is based on a measurement of a CSI reference signal. The UE may transmit partial CSI reports based at least in part on the configuration. Numerous other aspects are described.

### FIELD OF THE DISCLOSURE

Aspects of the present disclosure generally relate to wireless communication and to techniques and apparatuses for partial channel state information reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a configuration for partial channel state information (CSI) reports, each partial CSI report having less information than a full CSI report that is based on a measurement of a CSI reference signal. The method may include transmitting partial CSI reports based at least in part on the configuration.

Some aspects described herein relate to a method of wireless communication performed by a network entity. The method may include transmitting a configuration for partial CSI reports, each partial CSI report having less information than a full CSI report that is based on a measurement of a CSI reference signal. The method may include receiving partial CSI reports based at least in part on the configuration.

Some aspects described herein relate to a UE for wireless communication. The UE may include a memory and one or more processors coupled to the memory. The one or more processors may be configured to receive a configuration for partial CSI reports, each partial CSI report having less information than a full CSI report that is based on a measurement of a CSI reference signal. The one or more processors may be configured to transmit partial CSI reports based at least in part on the configuration.

Some aspects described herein relate to a network entity for wireless communication. The network entity may include a memory and one or more processors coupled to the memory. The one or more processors may be configured to transmit a configuration for partial CSI reports, each partial CSI report having less information than a full CSI report that is based on a measurement of a CSI reference signal. The one or more processors may be configured to receive partial CSI reports based at least in part on the configuration.

Some aspects described herein relate to a non-transitory computer-readable medium that stores a set of instructions for wireless communication by a UE. The set of instructions, when executed by one or more processors of the UE, may cause the UE to receive a configuration for partial CSI reports, each partial CSI report having less information than a full CSI report that is based on a measurement of a CSI reference signal. The set of instructions, when executed by one or more processors of the UE, may cause the UE to transmit partial CSI reports based at least in part on the configuration.

Some aspects described herein relate to a non-transitory computer-readable medium that stores a set of instructions for wireless communication by a network entity. The set of instructions, when executed by one or more processors of the network entity, may cause the network entity to transmit a configuration for partial CSI reports, each partial CSI report having less information than a full CSI report that is based on a measurement of a CSI reference signal. The set of instructions, when executed by one or more processors of the network entity, may cause the network entity to receive partial CSI reports based at least in part on the configuration.

Some aspects described herein relate to an apparatus for wireless communication. The apparatus may include means for receiving a configuration for partial CSI reports, each partial CSI report having less information than a full CSI report that is based on a measurement of a CSI reference signal. The apparatus may include means for transmitting partial CSI reports based at least in part on the configuration.

Some aspects described herein relate to an apparatus for wireless communication. The apparatus may include means for transmitting a configuration for partial CSI reports, each partial CSI report having less information than a full CSI report that is based on a measurement of a CSI reference signal. The apparatus may include means for receiving partial CSI reports based at least in part on the configuration.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity (e.g., base station) in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating examples of CSI reference signal (CSI-RS) beam management procedures, in accordance with the present disclosure.

FIG. 5 is a diagram illustrating an example of partial CSI reporting, in accordance with the present disclosure.

FIG. 6 is a diagram illustrating an example associated with partial CSI reporting, in accordance with the present disclosure.

FIG. 7 is a diagram illustrating an example process performed, for example, by a UE, in accordance with the present disclosure.

FIG. 8 is a diagram illustrating an example process performed, for example, by a network entity, in accordance with the present disclosure.

FIGS. 9-10 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

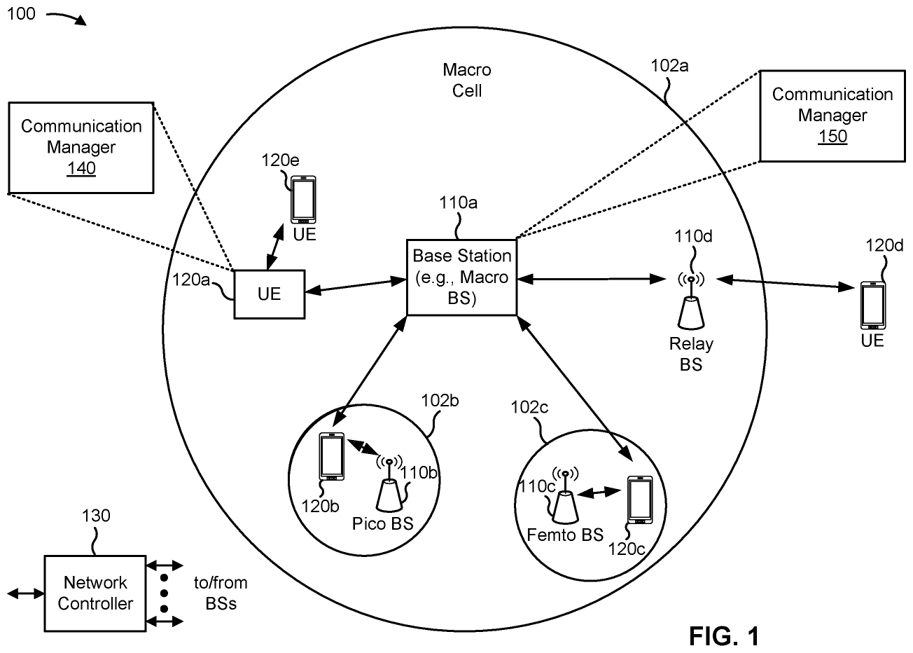

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration for reporting partial channel state information (CSI), each partial CSI report having less information than a full CSI report that is based on a measurement of a CSI reference signal. The communication manager 140 may transmit partial CSI reports based at least in part on the configuration. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit a configuration for partial CSI reports, each partial CSI report having less information than a full CSI report that is based on a measurement of a CSI reference signal. The communication manager 150 may receive partial CSI reports based at least in part on the configuration. Additionally, or alternatively, the communication manager 150 may perform one or more other operations described herein.

As indicated above, FIG. 1 is provided as an example. Other examples may differ from what is described with regard to FIG. 1.

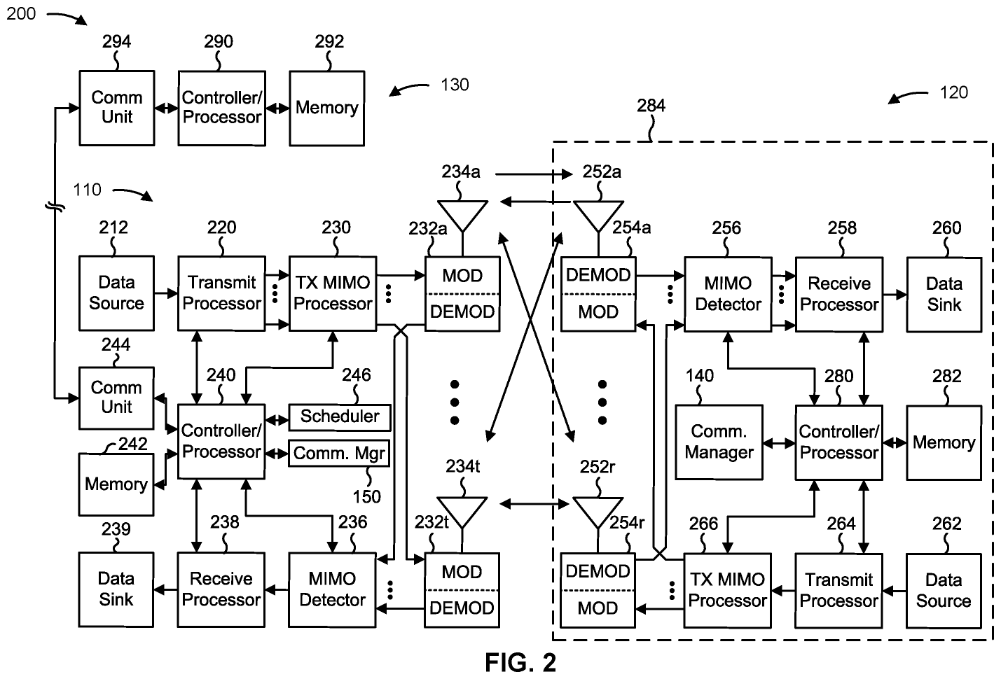

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

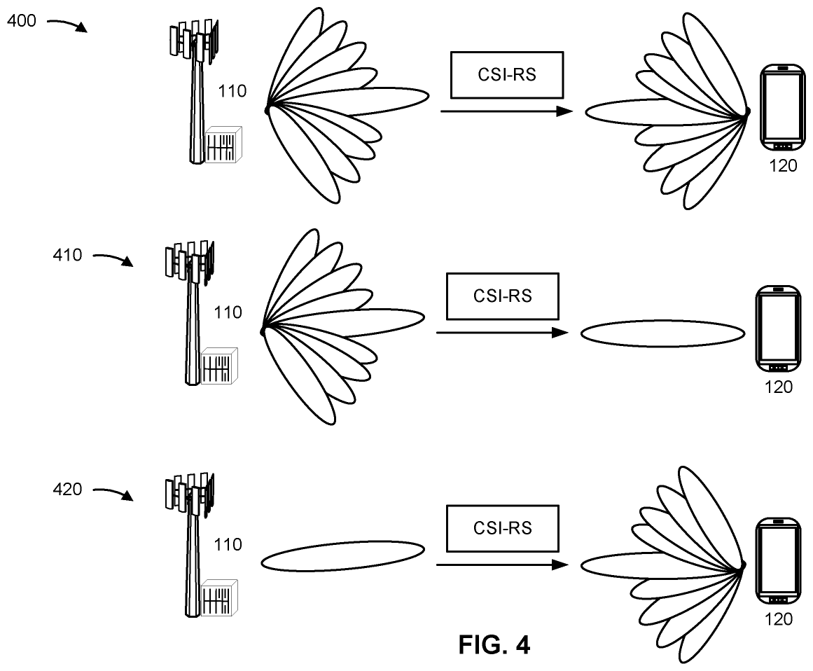

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

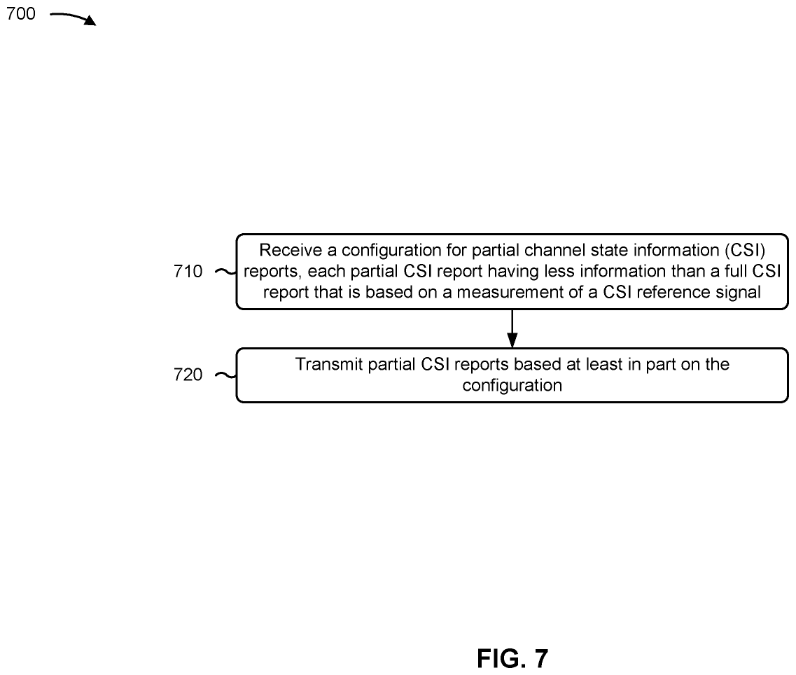

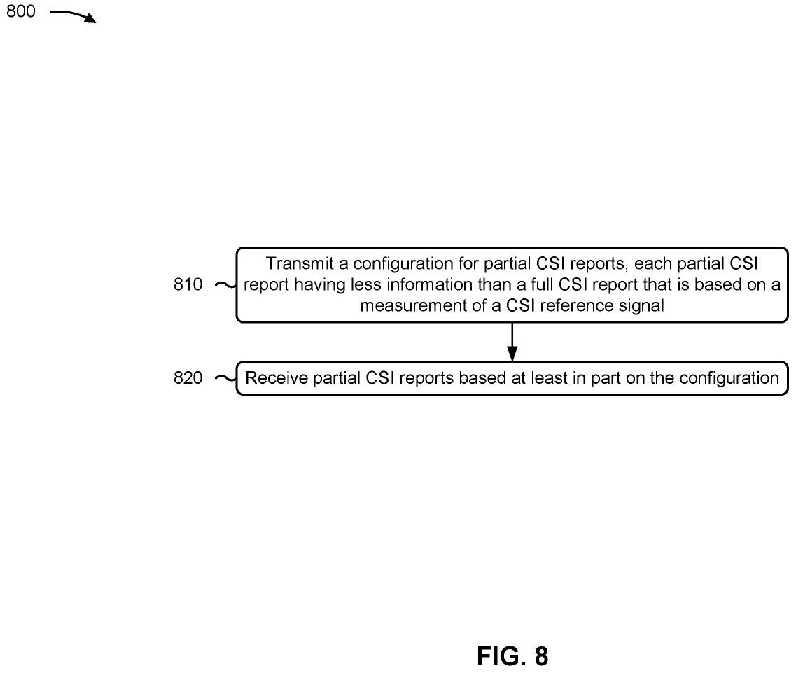

A controller/processor of a network entity (e.g., the controller/processor 240 of the base station 110), the controller/processor 280 of the UE 120, and/or any other component(s) of FIG. 2 may perform one or more techniques associated with partial CSI reporting, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving a configuration for partial CSI reports, each partial CSI report having less information than a full CSI report that is based on a measurement of a CSI reference signal; and/or means for transmitting partial CSI reports based at least in part on the configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) includes means for transmitting a configuration for partial CSI reports, each partial CSI report having less information than a full CSI report that is based on a measurement of a CSI reference signal; and/or means for receiving partial CSI reports based at least in part on the configuration. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

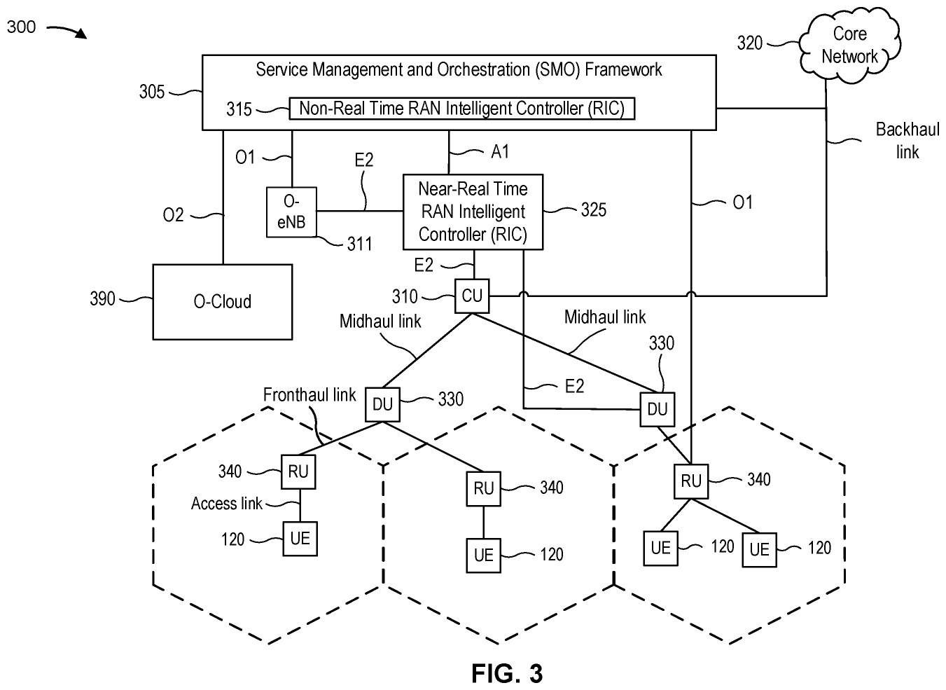

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an Fl interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units (e.g., the CUs 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit—User Plane (CU-UP)), control plane functionality (i.e., Central Unit—Control Plane (CU-CP)), or a combination thereof In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via O1 interface. Additionally, in some implementations, the SMO Framework 305 can communicate directly with one or more RUs 340 via O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating examples 400, 410, and 420 of CSI reference signal (CSI-RS) beam management procedures, in accordance with the present disclosure. As shown in FIG. 4, examples 400, 410, and 420 include a UE 120 in communication with a network entity (e.g., base station 110) in a wireless network (e.g., wireless network 100). However, the devices shown in FIG. 4 are provided as examples, and the wireless network may support communication and beam management between other devices (e.g., between a UE 120 and a base station 110 or TRP, between a mobile termination node and a control node, between an integrated access and backhaul (IAB) child node and an IAB parent node, and/or between a scheduled node and a scheduling node). In some aspects, the UE 120 and the base station 110 may be in a connected state (e.g., an RRC connected state).

As shown in FIG. 4, example 400 may include a network entity (e.g., one or more network node devices such as an RU, a DU, and/or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the base station 110 to the UE 120. The CSI-RSs may be configured to be periodic (e.g., using radio resource control (RRC) signaling), semi-persistent (e.g., using media access control (MAC) control element (MAC-CE) signaling), and/or aperiodic (e.g., using downlink control information (DCI)).

The first beam management procedure may include the network entity performing beam sweeping over multiple transmit (Tx) beams. The network entity may transmit a CSI-RS using each transmit beam for beam management. To enable the UE 120 to perform receive (Rx) beam sweeping, the network entity may use a transmit beam to transmit (e.g., with repetitions) each CSI-RS at multiple times within the same RS resource set so that the UE 120 can sweep through receive beams in multiple transmission instances. For example, if the network entity has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network entity, the UE 120 may perform beam sweeping through the receive beams of the UE 120. As a result, the first beam management procedure may enable the UE 120 to measure a CSI-RS on different transmit beams using different receive beams to support selection of network entity transmit beams/UE 120 receive beam(s) beam pair(s). The UE 120 may report the measurements to the network entity to enable the network entity to select one or more beam pair(s) for communication between the network entity and the UE 120. While example 400 has been described in connection with CSI-RSs, the first beam management process may also use synchronization signal blocks (SSBs) for beam management in a similar manner as described above.

As shown in FIG. 4, example 410 may include a network entity (e.g., base station 110) and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

A full CSI report may include report metrics such as a CQI, a precoding matrix index (PMI), and/or a rank indicator (RI) based at least in part on measurement of a CSI-RS at a CSI-RS measurement occasion. When the UE 120 is moving fast with a high Doppler effect, the CSI feedback may not be able to catch up with the channel time variation, and the precoding matrix may become invalid. Because the network entity uses the precoding matrix indicate in or obtained via the CSI feedback, there may be a mismatch between the CSI feedback and the actual channel variation. This may cause transmission failure.

Some solutions may involve additional signaling to change the periodicities of CSI reports to adapt to the UE movement and/or channel variations. However, this increases overhead. Other solutions may involve enhancing the CSI codebook to track channel variations affected by fast movement. However, this would increase UE complexity.

As indicated above, FIG. 4 is provided as an example of beam management procedures. Other examples of beam management procedures may differ from what is described with respect to FIG. 4. For example, the UE 120 and the base station 110 may perform the third beam management procedure before performing the second beam management procedure, and/or the UE 120 and the base station 110 may perform a similar beam management procedure to select a UE transmit beam.

As indicated above, FIG. 4 is provided as an example. Other examples may differ from what is described with regard to FIG. 4.

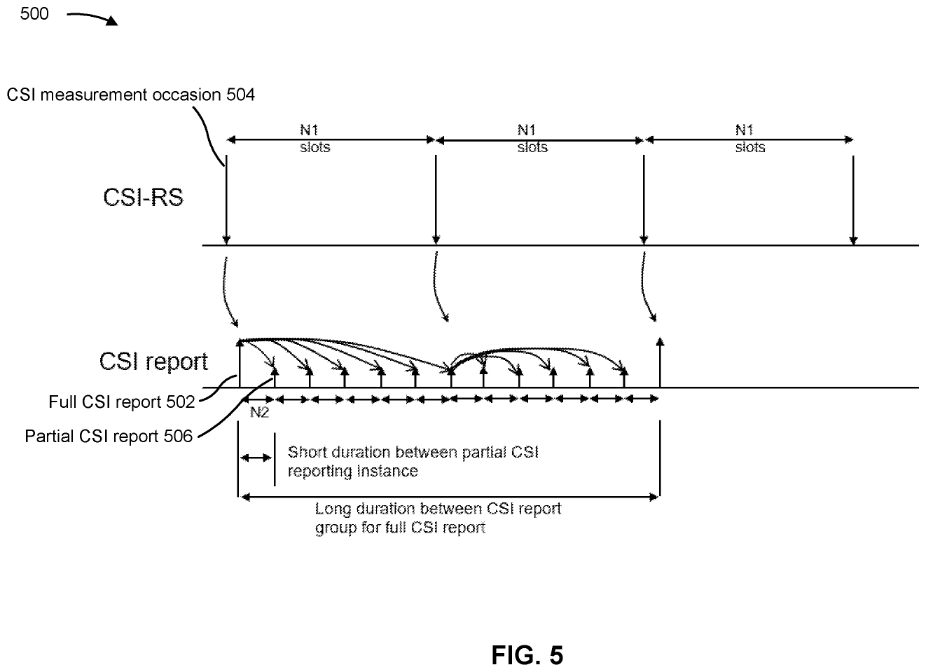

FIG. 5 is a diagram illustrating an example 500 of partial CSI reporting, in accordance with the present disclosure.

According to various aspects described herein, a UE may transmit partial CSI reports that are relative to a reference CSI (e.g., a full CSI report, a latest measurement). The CSI reports may be configured to be periodic or semi-persistent. Aperiodic CSI reports may also be used. The full CSI report may include a precoder W₂, which is a coefficient matrix that indicates how to associate precoding weights to the spatial domain basis and frequency domain basis vectors. Precoder W₂ is for Type-II codebooks and \tilde{W}₂ is for eType-II codebooks. A partial CSI report may include less information than the CSI full report. For example, a report metric for the partial CSI report (e.g., based on the latest measurement for time stamp (nN₁)) may be a delta update of the actual precoder W₂ or \tilde{W}₂ for type-II and eType-II PMI, respectively. The quantity of slots between CSI measurement occasions may be represented by NI, and the index n may indicate a slot (slot index). The delta update in the partial CSI may be represented by ΔW₂^{(nN}^{ₛ}⁾=W₂^{(nN}^{₁}⁾=W₂^{(ref)} or Δ\tilde{W}₂^{(nN}^{ₛ}⁾=\tilde{W}₂^{(nN}^{₁}⁾=\tilde{W}₂^{(ref)}. The reference may be a CSI measurement occasion for a full CSI report. In another example, the report metric for the partial CSI report nNi) (e.g., based on the latest measurement) may be a delta update of a representation of the precoder W₂ or \tilde{W}₂ for type-II and eType-II PMI, respectively. If W₂^{(nN}^{₁}⁾=UΛ^{(nN}^{₁}⁾V^{H} and W₂^{(ref)}=UΛ^{(ref)}V^{H} are each a representation of the precoder matrix, then the partial CSI report may be represented as Δ^{(nN}^{₁}⁾=Λ^{(nN}^{₁}⁾=Λ^{(ref)}. Likewise, the representation may be for \tilde{W}₂^{(nN}^{₁}⁾. Similarly, the report metric for the partial CSI based on prediction for time stamp (nN₁+mN₂) may be a delta update for the precoder (actual or representation) of the precoder relative to the latest measurement, represented as ΔW₂^{(nN}^{₁}^{+mN}^{₂}⁾=W₂^{(nN}^{₁}^{+mN}^{₂}⁾=W₂^{(nN}^{₁}⁾.

The reporting rate of the partial CSI reports may be different than the reporting rate of the full CSI reports. Example 500 shows full CSI reports 502 at CSI measurement occasions 504 with a time duration of N1 slots between CSI measurement occasions. Example 500 also shows partial CSI reports 506 between the CSI measurement occasions 504 with a time duration of N2 between reporting instances of the partial CSI reports 506. There may be multiple partial CSI reports 506 between the full CSI reports 502. The network entity may configure the UE with uplink resources for transmitting the partial CSI reports. The uplink resources may be part of a resource group. The uplink resources may include aperiodic physical uplink control channel (PUCCH) resources or semi-periodic PUCCH resources with different periodicities. An uplink resource for partial CSI reports may have a different periodicity than CSI measurement occasions for full CSI reports. The network entity may configure a second PUCCH resource that corresponds to the remaining uplink resources of the resource group.

The partial CSI reports may be timestamped (e.g., associated with a time, symbol, or slot) independent of timestamps of the CSI measurement occasions. Partial CSI reports may have a timestamp that is the same as a CSI measurement occasion timestamp or that is within a configured time threshold of the CSI measurement occasion timestamp. The reference CSI may be a full CSI report or information indicated by the network entity.

In some aspects, the UE may generate partial CSI reports based at least in part on a latest measurement of a CSI-RS at a most recent CSI measurement occasion. The latest measurement may be relative to a reference CSI (e.g., full CSI report). In some aspects, the UE may generate partial CSI based at least in part on CSI prediction. For example, the UE may predict a delta update based at least in part on a history of past measurements and/or any determined trends. For example, a prediction for a partial CSI report may be relative to a reference CSI, which may be CSI that is based on a latest measurement. A partial CSI report that is based on a prediction may be for a future timestamp, after a configured threshold but within a prediction window starting from the latest measurement occasion timestamp.

By transmitting delta updates in partial CSI reports more frequently than full CSI reports, the UE may provide up-to-date CSI for fast moving UEs without changing the codebooks. As a result, the network entity may have more accurate channel information and communications may improve without increasing UE complexity. Furthermore, less overhead may be used to conserve signaling resources.

As indicated above, FIG. 5 is provided as an example. Other examples may differ from what is described with respect to FIG. 5.

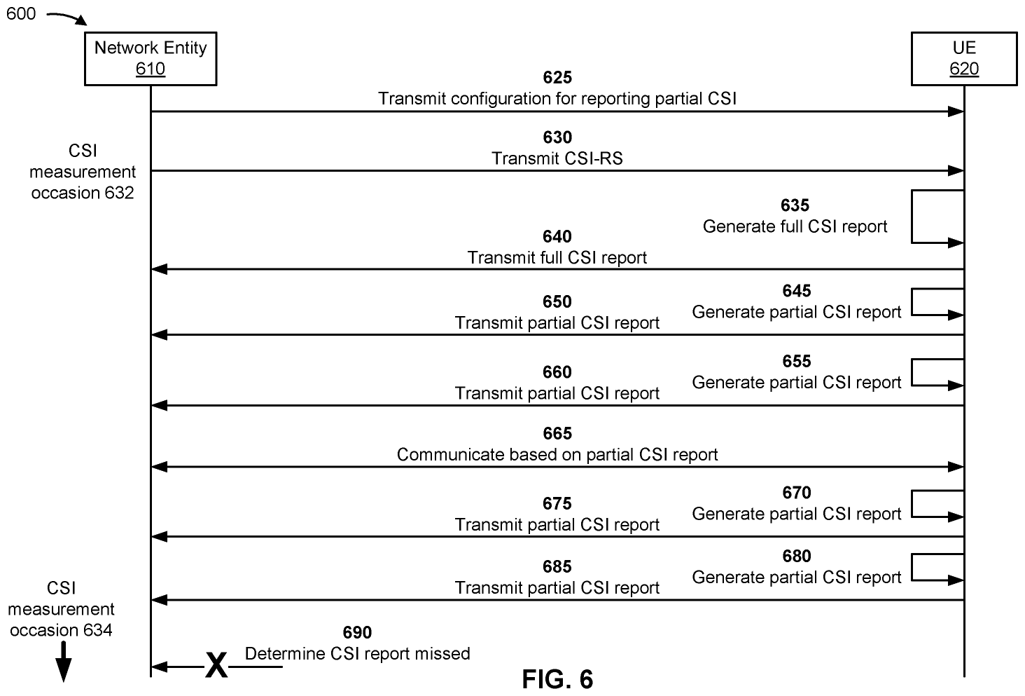

FIG. 6 is a diagram illustrating an example 600 associated with partial CSI reporting, in accordance with the present disclosure. As shown in FIG. 6, a network entity 610 (e.g., base station 110) and a UE 620 (e.g., a UE 120) may communicate with one another via a wireless network (e.g., wireless network 100).

As shown by reference number 625, the network entity 610 may transmit a configuration for partial CSI reports. As shown by reference number 630, the network entity 610 may transmit a CSI-RS at a CSI measurement occasion 632. The next CSI measurement occasion 634 for the next CSI-RS transmission is later in time than the steps shown in example 600. As shown by reference number 635, the UE 620 may generate a full CSI report. As shown by reference number 640, the UE 620 may transmit the full CSI report.

The UE 620 may transmit partial CSI reports in between the full CSI reports that are generated at the CSI measurement occasions. That is, the UE 620 may transmit partial CSI reports at a different reporting rate than for full CSI reports. As shown by reference number 645, the UE 620 may generate a partial CSI report based at least in part on a latest measurement and/or a prediction. The partial CSI report may include a delta update as described in connection with FIG. 5. As shown by reference number 650, the UE 620 may transmit the partial CSI report. As shown by reference number 655, the UE 620 may generate another partial CSI report at the next partial CSI reporting instance. As shown by reference number 660, the UE 620 may transmit the partial CSI report.

The network entity 610 may receive and use the partial CSI report in combination with a recent full CSI report. The network entity 610 may determine a channel variation due to the fast movement of the UE 620. As shown by reference number 665, the network entity 610 may communicate based at least in part on the partial CSI report. For example, the network entity 610 may select a precoding matrix based at least in part on the channel variation indicated by the partial CSI report and transmit a communication using the precoding matrix.

The UE 620 may continue to generate and send partial CSI reports before the next CSI measurement occasion 634. This may be in case the network entity 610 or the UE 620 transmits a communication between CSI-RSs. As shown by reference number 670, the UE 620 may generate a partial CSI report. As shown by reference number 675, the UE 620 may transmit the partial CSI report. As shown by reference number 680, the UE 620 may generate another partial CSI report at the next partial CSI reporting instance. As shown by reference number 685, the UE 620 may transmit the partial CSI report. This may continue until the UE 620 generates and transmits another full CSI report at the next CSI measurement occasion 634.

In some aspects, the network entity 610 may determine that a CSI report has been missed, as shown by reference number 690. This may include one or multiple missed CSI reports. Missed CSI reports may include a full CSI report and/or any quantity of partial CSI reports. The network entity 610 may configure the UE 620, or indicate to the UE 620, to retransmit a missed CSI report and indicate a position (e.g., location, reporting time instance, time reference) of the missed CSI report (when the missed CSI report was originally expected). The network entity 610 may use the position of the CSI report to accurately determine the channel variation with the retransmitted CSI report, with respect to other CSI reports. If the UE 620 reports a position of the missed CSI report (or positions of multiple missed CSI reports) when resending a CSI report, this may avoid problems associated with using delta updates that are relative to a reference CSI. The network entity 610 may transmit a configuration that indicates a new field in DCI related to a missed CSI report position or a field that is to be reused or modified to indicate the missed CSI report position. The configuration may be the same as the configuration for partial CSI reports or a separate configuration.

In some aspects, the configuration may indicate an aperiodic uplink resource for retransmitting a CSI report. An aperiodic uplink resource for retransmission may be in the same slot as a periodic uplink resource or a semi-persistent uplink resource for a new CSI report. If a retransmitted CSI report and the new CSI report are in the same slot, the retransmitted CSI report and the new CSI report may be multiplexed.

In some aspects, the network entity 610 may signal, via the configuration for the partial CSI reports or a separate configuration or indication, activation or deactivation of partial CSI reporting. The partial CSI reporting may be periodic, semi-persistent, or at an aperiodic CSI reporting occasion. The signal may be via DCI or a MAC CE. The signal may activate partial CSI reporting (e.g., based on a latest measurement, based on prediction) for a specified time duration, which may start from the instance in which the signal is received. That is, the partial CSI reporting may take place during the specified time duration and stop after an end of the specified time duration. The specified time duration may be configured via RRC configuration or stored in configuration information at the UE 620.

For aperiodic CSI (A-CSI) reporting, the UE 620 may be configured (e.g., via RRC) with a list of aperiodic trigger states, which can be activated later via a MAC CE. Then, among the selected/active CSI-RS trigger states, the network entity 610 may request a CSI report for the CSI trigger state (measurement resource+reporting resource) using a codepoint (bits) in a DCI field (CSI request). In some aspects, the activation signal may be either common DCI or MAC CE signaling. For example, DCI may trigger A-CSI reporting, and a new DCI field may indicate whether the triggered A-CSI reporting is a reference CSI. Later, another A-CSI triggering DCI with the same triggering state may indicate whether the A-CSI reporting is for partial CSI reporting with respect to the previous A-CSI of the same triggering state. That is, partial CSI reporting signaling may be based at least in part on a triggering state. Consequently, multiple A-CSIs with different triggering states may have different reference CSIs.

In some aspects, the network entity 610 may signal deactivation of partial CSI reporting (e.g., via DCI or a MAC CE). This may be at the request of the UE 620. By signaling activation and/or deactivation of partial CSI reporting, the network entity 610 may have more flexibility for improving CSI feedback when the UE 620 is traveling at a fast rate (e.g., greater than a velocity threshold).

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., a UE 120, UE 620) performs operations associated with partial CSI reporting.

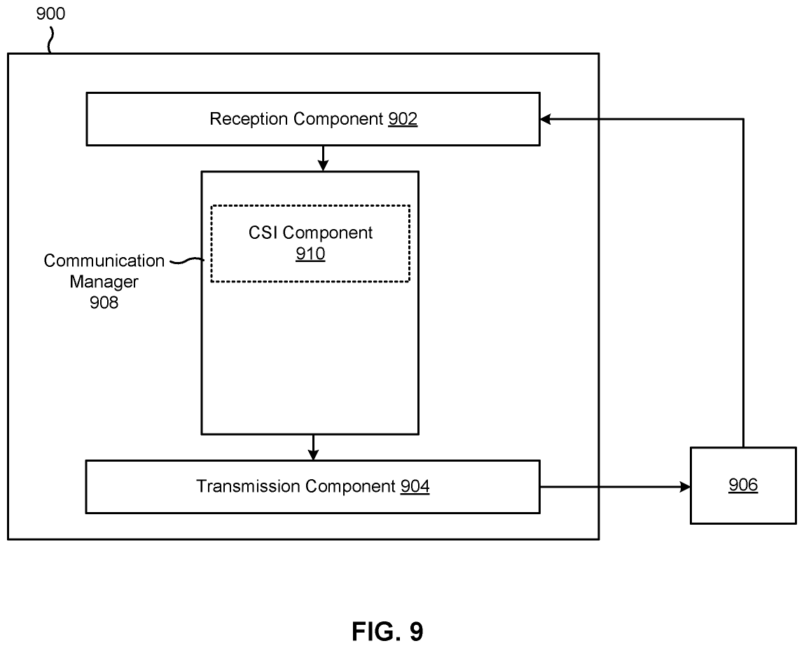

As shown in FIG. 7, in some aspects, process 700 may include receiving a configuration for partial CSI reports, each partial CSI report having less information than a full CSI report that is based on a measurement of a CSI reference signal (block 710). For example, the UE (e.g., using communication manager 908 and/or reception component 902 depicted in FIG. 9) may receive a configuration for partial CSI reports, each partial CSI report having less information than a full CSI report that is based on a measurement of a CSI reference signal, as described above.

As further shown in FIG. 7, in some aspects, process 700 may include transmitting partial CSI reports based at least in part on the configuration (block 720). For example, the UE (e.g., using communication manager 908 and/or transmission component 904 depicted in FIG. 9) may transmit partial CSI reports based at least in part on the configuration, as described above.

Process 700 may include additional aspects, such as any single aspect or any combination of aspects described below and/or in connection with one or more other processes described elsewhere herein.

In a first aspect, process 700 includes transmitting full CSI reports, where a reporting rate of the partial CSI reports is different than a reporting rate of the full CSI reports.

In a second aspect, alone or in combination with the first aspect, transmitting the partial CSI reports includes transmitting the partial CSI reports between CSI measurement occasions.

In a third aspect, alone or in combination with one or more of the first and second aspects, process 700 includes generating the partial CSI reports based at least in part on predictions of CSI relative to a reference CSI.

In a fourth aspect, alone or in combination with one or more of the first through third aspects, the reference CSI is CSI that is based on a latest CSI measurement.

In a fifth aspect, alone or in combination with one or more of the first through fourth aspects, a report metric for the partial CSI reports is a delta update of an actual precoder or a representation of a precoder relative to the latest CSI measurement.

In a sixth aspect, alone or in combination with one or more of the first through fifth aspects, the reference CSI is a full CSI report.

In a seventh aspect, alone or in combination with one or more of the first through sixth aspects, process 700 includes receiving an indication of the reference CSI.

In an eighth aspect, alone or in combination with one or more of the first through seventh aspects, generating the partial CSI reports includes generating the partial CSI reports for future timestamps after a configured time threshold and within a prediction time window that starts from a timestamp of a latest CSI measurement.

In a ninth aspect, alone or in combination with one or more of the first through eighth aspects, process 700 includes generating the partial CSI reports based at least in part on a latest CSI measurement.

In a tenth aspect, alone or in combination with one or more of the first through ninth aspects, a timestamp for the latest CSI measurement is the same as or within a configured time threshold of a timestamp of a measurement occasion.

In an eleventh aspect, alone or in combination with one or more of the first through tenth aspects, a report metric for the partial CSI reports is a delta update of an actual precoder for a Type-II PMI or an eType-II PMI.

In a twelfth aspect, alone or in combination with one or more of the first through eleventh aspects, a report metric for the partial CSI reports is a delta update of a representation of a precoder for a Type-II PMI or an eType-II PMI.

In a thirteenth aspect, alone or in combination with one or more of the first through twelfth aspects, process 700 includes timestamping the partial CSI reports independent of timestamps of measurement occasions.

In a fourteenth aspect, alone or in combination with one or more of the first through thirteenth aspects, the configuration indicates uplink resources for the partial CSI reports.

In a fifteenth aspect, alone or in combination with one or more of the first through fourteenth aspects, the uplink resources include aperiodic PUCCH resources or semi-persistent PUCCH resources with a different periodicity than measurement occasions for full CSI reports.

In a sixteenth aspect, alone or in combination with one or more of the first through fifteenth aspects, process 700 includes transmitting an indication of a position of a missed CSI report.

In a seventeenth aspect, alone or in combination with one or more of the first through sixteenth aspects, process 700 includes receiving an indication to activate partial CSI reporting for a specified time duration, and transmitting the partial CSI reports includes transmitting the partial CSI reports only for the specified time duration.

In an eighteenth aspect, alone or in combination with one or more of the first through seventeenth aspects, the indication is associated with DCI that triggers aperiodic CSI reporting.

In a nineteenth aspect, alone or in combination with one or more of the first through eighteenth aspects, process 700 includes receiving an indication to deactivate partial CSI reporting, and refraining from transmitting further partial CSI reports after receiving the indication.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network entity, in accordance with the present disclosure. Example process 800 is an example where the network entity (e.g., base station 110, network entity 610) performs operations associated with partial CSI reporting.

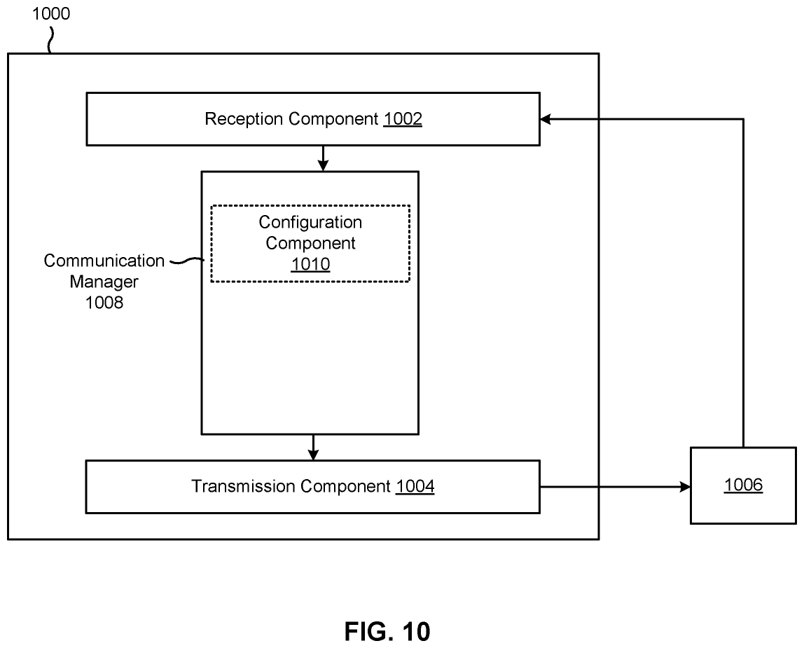

As shown in FIG. 8, in some aspects, process 800 may include transmitting a configuration for partial CSI reports, each partial CSI report having less information than a full CSI report that is based on a measurement of a CSI reference signal (block 810). For example, the network entity (e.g., using communication manager 1008 and/or transmission component 1004 depicted in FIG. 10) may transmit a configuration for partial CSI reports, each partial CSI report having less information than a full CSI report that is based on a measurement of a CSI reference signal, as described above.

As further shown in FIG. 8, in some aspects, process 800 may include receiving partial CSI reports based at least in part on the configuration (block 820). For example, the network entity (e.g., using communication manager 1008 and/or reception component 1002 depicted in FIG. 10) may receive partial CSI reports based at least in part on the configuration, as described above.

Process 800 may include additional aspects, such as any single aspect or any combination of aspects described below and/or in connection with one or more other processes described elsewhere herein.

In a first aspect, process 800 includes receiving full CSI reports, where a reporting rate of the partial CSI reports is different than a reporting rate of the full CSI reports.

In a second aspect, alone or in combination with the first aspect, receiving the partial CSI reports includes receiving the partial CSI reports between CSI measurement occasions.

In a third aspect, alone or in combination with one or more of the first and second aspects, a report metric for the partial CSI reports is a delta update of an actual precoder or a representation of a precoder relative to a reference CSI.

In a fourth aspect, alone or in combination with one or more of the first through third aspects, process 800 includes transmitting an indication of the reference CSI.

In a fifth aspect, alone or in combination with one or more of the first through fourth aspects, a report metric for the partial CSI reports is a delta update of an actual precoder for a Type-II PMI or an eType-II PMI.

In a sixth aspect, alone or in combination with one or more of the first through fifth aspects, a report metric for the partial CSI reports is a delta update of a representation of a precoder for a Type-II PMI or an eType-II PMI.

In a seventh aspect, alone or in combination with one or more of the first through sixth aspects, the configuration indicates uplink resources for the partial CSI reports.

In an eighth aspect, alone or in combination with one or more of the first through seventh aspects, the configuration indicates a field for reporting a CSI position in association with missed CSI reports, and process 800 includes receiving an indication of a position of a CSI report in the field.

In a ninth aspect, alone or in combination with one or more of the first through eighth aspects, process 800 includes transmitting an indication to activate partial CSI reporting for a specified time duration.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE (e.g., a UE 120, UE 620), or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 908. The communication manager 908 may control and/or otherwise manage one or more operations of the reception component 902 and/or the transmission component 904. In some aspects, the communication manager 908 may include one or more antennas, a modem, a controller/processor, a memory, or a combination thereof, of the UE described in connection with FIG. 2. The communication manager 908 may be, or be similar to, the communication manager 140 depicted in FIGS. 1 and 2. For example, in some aspects, the communication manager 908 may be configured to perform one or more of the functions described as being performed by the communication manager 140. In some aspects, the communication manager 908 may include the reception component 902 and/or the transmission component 904. The communication manager 908 may include a CSI component 910, among other examples.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive a configuration for partial CSI reports, each partial CSI report having less information than a full CSI report that is based on a measurement of a CSI reference signal. The transmission component 904 may transmit partial CSI reports based at least in part on the configuration. The transmission component 904 may transmit full CSI reports, wherein a reporting rate of the partial CSI reports is different than a reporting rate of the full CSI reports.

The CSI component 910 may generate the partial CSI reports based at least in part on predictions of CSI relative to a reference CSI. The reception component 902 may receive an indication of the reference CSI. The CSI component 910 may generate the partial CSI reports based at least in part on a latest CSI measurement.

The CSI component 910 may timestamp the partial CSI reports independent of timestamps of measurement occasions. The transmission component 904 may transmit an indication of a position of a missed CSI report.

The reception component 902 may receive an indication to activate partial CSI reporting for a specified time duration, and the transmission component 904 may transmit the partial CSI reports only for the specified time duration. The reception component 902 may receive an indication to deactivate partial CSI reporting. The CSI component 910 may refrain from transmitting further partial CSI reports after receiving the indication.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network entity (e.g., base station 110, network entity 610), or a network entity may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 1008. The communication manager 1008 may control and/or otherwise manage one or more operations of the reception component 1002 and/or the transmission component 1004. In some aspects, the communication manager 1008 may include one or more antennas, a modem, a controller/processor, a memory, or a combination thereof, of the network entity described in connection with FIG. 2. The communication manager 1008 may be, or be similar to, the communication manager 150 depicted in FIGS. 1 and 2. For example, in some aspects, the communication manager 1008 may be configured to perform one or more of the functions described as being performed by the communication manager 150. In some aspects, the communication manager 1008 may include the reception component 1002 and/or the transmission component 1004. The communication manager 1008 may include a configuration component 1010, among other examples.

In some aspects, the apparatus 1000 may be configured to perform one or more operations described herein in connection with FIGS. 1-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network entity described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network entity described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network entity described in connection with FIG. 2. In some aspects, the transmission component 1004 may be co-located with the reception component 1002 in a transceiver.

The transmission component 1004 may transmit a configuration for partial CSI reports, each partial CSI report having less information than a full CSI report that is based on a measurement of a CSI reference signal. The configuration component 1010 may generate the configuration based at least in part on a UE capability, a UE status, a UE location, traffic conditions, and/or channel conditions. The reception component 1002 may receive partial CSI reports based at least in part on the configuration.

The reception component 1002 may receive full CSI reports, where a reporting rate of the partial CSI reports is different than a reporting rate of the full CSI reports. The transmission component 1004 may transmit an indication of the reference CSI. The transmission component 1004 may transmit an indication to activate partial CSI reporting for a specified time duration.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving a configuration for partial channel state information (CSI) reports, each partial CSI report having less information than a full CSI report that is based on a measurement of a CSI reference signal; and transmitting partial CSI reports based at least in part on the configuration.

Aspect 2: The method of Aspect 1, further comprising transmitting full CSI reports, wherein a reporting rate of the partial CSI reports is different than a reporting rate of the full CSI reports.

Aspect 3: The method of Aspect 1 or 2, wherein transmitting the partial CSI reports includes transmitting the partial CSI reports between CSI measurement occasions.

Aspect 4: The method of any of Aspects 1-3, further comprising generating the partial CSI reports based at least in part on predictions of CSI relative to a reference CSI.

Aspect 5: The method of Aspect 4, wherein the reference CSI is CSI that is based on a latest CSI measurement.

Aspect 6: The method of Aspect 5, wherein a report metric for the partial CSI reports is a delta update of an actual precoder or a representation of a precoder relative to the latest CSI measurement.

Aspect 7: The method of Aspect 4, wherein the reference CSI is a full CSI report.

Aspect 8: The method of any of Aspects 4-7, further comprising receiving an indication of the reference CSI.

Aspect 9: The method of any of Aspects 4-7, wherein generating the partial CSI reports includes generating the partial CSI reports for future timestamps after a configured time threshold and within a prediction time window that starts from a timestamp of a latest CSI measurement.

Aspect 10: The method of any of Aspects 1-9, further comprising generating the partial CSI reports based at least in part on a latest CSI measurement.

Aspect 11: The method of Aspect 10, wherein a timestamp for the latest CSI measurement is the same as or within a configured time threshold of a timestamp of a measurement occasion.

Aspect 12: The method of any of Aspects 1-10, wherein a report metric for the partial CSI reports is a delta update of an actual precoder for a Type-II precoding matrix indicator (PMI) or an eType-II PMI.

Aspect 13: The method of any of Aspects 1-10, wherein a report metric for the partial CSI reports is a delta update of a representation of a precoder for a Type-II precoding matrix indicator (PMI) or an eType-II PMI.

Aspect 14: The method of any of Aspects 1-13, further comprising timestamping the partial CSI reports independent of timestamps of measurement occasions.

Aspect 15: The method of any of Aspects 1-14, wherein the configuration indicates uplink resources for the partial CSI reports.

Aspect 16: The method of Aspect 15, wherein the uplink resources include aperiodic physical uplink control channel (PUCCH) resources or semi-persistent PUCCH resources with a different periodicity than measurement occasions for full CSI reports.

Aspect 17: The method of any of Aspects 1-16, further comprising transmitting an indication of a position of a missed CSI report.

Aspect 18: The method of any of Aspects 1-17, further comprising receiving an indication to activate partial CSI reporting for a specified time duration, and wherein transmitting the partial CSI reports includes transmitting the partial CSI reports only for the specified time duration.

Aspect 19: The method of Aspect 18, wherein the indication is associated with downlink control information that triggers aperiodic CSI reporting.

Aspect 20: The method of any of Aspects 1-19, further comprising: receiving an indication to deactivate partial CSI reporting; and refraining from transmitting further partial CSI reports after receiving the indication.

Aspect 21: A method of wireless communication performed by a network entity, comprising: transmitting a configuration for partial channel state information (CSI) reports, each partial CSI report having less information than a full CSI report that is based on a measurement of a CSI reference signal; and receiving partial CSI reports based at least in part on the configuration.

Aspect 22: The method of Aspect 21, further comprising receiving full CSI reports, wherein a reporting rate of the partial CSI reports is different than a reporting rate of the full CSI reports.

Aspect 23: The method of Aspect 21 or 22, wherein receiving the partial CSI reports includes receiving the partial CSI reports between CSI measurement occasions.

Aspect 24: The method of any of Aspects 21-23, wherein a report metric for the partial CSI reports is a delta update of an actual precoder or a representation of a precoder relative to a reference CSI.

Aspect 25: The method of Aspect 24, further comprising transmitting an indication of the reference CSI.

Aspect 26: The method of any of Aspects 21-25, wherein a report metric for the partial CSI reports is a delta update of an actual precoder for a Type-II precoding matrix indicator (PMI) or an eType-II PMI.

Aspect 27: The method of any of Aspects 21-25, wherein a report metric for the partial CSI reports is a delta update of a representation of a precoder for a Type-II precoding matrix indicator (PMI) or an eType-II PMI.

Aspect 28: The method of any of Aspects 21-27, wherein the configuration indicates uplink resources for the partial CSI reports.

Aspect 29: The method of any of Aspects 21-28, wherein the configuration indicates a field for reporting a CSI position in association with missed CSI reports, and wherein the method further comprises receiving an indication of a position of a CSI report in the field.

Aspect 30: The method of any of Aspects 21-29, further comprising transmitting an indication to activate partial CSI reporting for a specified time duration.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a configuration for partial channel state information (CSI) reports, each partial CSI report having less information than a full CSI report that is based on a measurement of a CSI reference signal; and
transmit partial CSI reports based at least in part on the configuration.

2. The UE of claim 1, wherein the one or more processors are configured to transmit full CSI reports, wherein a reporting rate of the partial CSI reports is different than a reporting rate of the full CSI reports.

3. The UE of claim 1, wherein the one or more processors, to transmit the partial CSI reports, are configured to transmit the partial CSI reports between CSI measurement occasions.

4. The UE of claim 1, wherein the one or more processors are configured to generate the partial CSI reports based at least in part on predictions of CSI relative to a reference CSI.

5. The UE of claim 4, wherein the reference CSI is CSI that is based on a latest CSI measurement.

6. The UE of claim 5, wherein a report metric for the partial CSI reports is a delta update of an actual precoder or a representation of a precoder relative to the latest CSI measurement.

7. The UE of claim 4, wherein the reference CSI is a full CSI report.

8. The UE of claim 4, wherein the one or more processors are configured to receive an indication of the reference CSI.

9. The UE of claim 4, wherein the one or more processors, to generate the partial CSI reports, are configured to generate the partial CSI reports for future timestamps after a configured time threshold and within a prediction time window that starts from a timestamp of a latest CSI measurement.

10. The UE of claim 1, wherein the one or more processors are configured to generate the partial CSI reports based at least in part on a latest CSI measurement.

11. The UE of claim 10, wherein a timestamp for the latest CSI measurement is the same as or within a configured time threshold of a timestamp of a measurement occasion.

12. The UE of claim 11, wherein a report metric for the partial CSI reports is a delta update of an actual precoder for a Type-II precoding matrix indicator (PMI) or an eType-II PMI.

13. The UE of claim 11, wherein a report metric for the partial CSI reports is a delta update of a representation of a precoder for a Type-II precoding matrix indicator (PMI) or an eType-II PMI.

14. The UE of claim 1, wherein the one or more processors are configured to timestamp the partial CSI reports independent of timestamps of measurement occasions.

15. The UE of claim 1, wherein the configuration indicates uplink resources for the partial CSI reports.

16. The UE of claim 15, wherein the uplink resources include aperiodic physical uplink control channel (PUCCH) resources or semi-persistent PUCCH resources with a different periodicity than measurement occasions for full CSI reports.

17. The UE of claim 1, wherein the one or more processors are configured to transmit an indication of a position of a missed CSI report.

18. The UE of claim 1, wherein the one or more processors are configured to receive an indication to activate partial CSI reporting for a specified time duration, and wherein the one or more processors, to transmit the partial CSI reports, are configured to transmit the partial CSI reports only for the specified time duration.

19. The UE of claim 18, wherein the indication is associated with downlink control information that triggers aperiodic CSI reporting.

20. The UE of claim 1, wherein the one or more processors are configured to:
receive an indication to deactivate partial CSI reporting; and
refrain from transmitting further partial CSI reports after receiving the indication.

21. A network entity for wireless communication, comprising:
a memory; and
one or more processors, coupled to the memory, configured to:
transmit a configuration for partial channel state information (CSI) reports, each partial CSI report having less information than a full CSI report that is based on a measurement of a CSI reference signal; and
receive partial CSI reports based at least in part on the configuration.

22. The network entity of claim 21, wherein the one or more processors are configured to receive full CSI reports, wherein a reporting rate of the partial CSI reports is different than a reporting rate of the full CSI reports.

23. The network entity of claim 21, wherein the one or more processors, to receive the partial CSI reports, are configured to receive the partial CSI reports between CSI measurement occasions.

24. The network entity of claim 21, wherein a report metric for the partial CSI reports is a delta update of an actual precoder or a representation of a precoder relative to a reference CSI.

25. The network entity of claim 24, wherein the one or more processors are configured to transmit an indication of the reference CSI.

26. The network entity of claim 21, wherein a report metric for the partial CSI reports is a delta update of an actual precoder for a Type-II precoding matrix indicator (PMI) or an eType-II PMI.

27. The network entity of claim 21, wherein a report metric for the partial CSI reports is a delta update of a representation of a precoder for a Type-II precoding matrix indicator (PMI) or an eType-II PMI.

28. The network entity of claim 21, wherein the configuration indicates uplink resources for the partial CSI reports.

29. The network entity of claim 21, wherein the configuration indicates a field for reporting a CSI position in association with missed CSI reports, and wherein the one or more processors are configured to receive an indication of a position of a CSI report in the field.

30. The network entity of claim 21, wherein the one or more processors are configured to transmit an indication to activate partial CSI reporting for a specified time duration.
